(19) United States
(12) Patent Application Publication
(10) Pub. No.: US 2024/0067848 A1
(43) Pub. Date: Feb. 29, 2024

(54) ADHESIVE LABELS COMPRISING BIODEGRADABLE AQUEOUS POLYURETHANE PRESSURE-SENSITIVE ADHESIVE

(71) Applicant: BASF SE, Ludwigshafen am Rhein (DE)

(72) Inventors: Paul ACHATZ, Ludwigshafen am Rhein (DE); Jeremy Jon SLOAN, Ludwigshafen am Rhein (DE); Jose Maria TORRES LLOSA, Ludwigshafen am Rhein (DE); Ulrike LICHT, Ludwigshafen am Rhein (DE)

(21) Appl. No.: 18/278,435

(22) PCT Filed: Feb. 16, 2022
(86) PCT No.: PCT/EP2022/053803

§ 371 Date: Aug. 23, 2023

(30) Foreign Application Priority Data
Feb. 24, 2021 (EP) 21158974.2

(51) Int. Cl. C09J 7/38; C09J 7/21; C09J 7/40; C09J 175/06

(52) U.S. Cl. CPC C09J 7/38; C09J 7/21; C09J 7/40; C09J 175/06; C09J 2203/334; C09J 2301/302; C09J 2301/312

(57) ABSTRACT

An adhesive label is described comprising a backing material, a pressure-sensitive adhesive layer attached to the backing material and either a release liner attached to the adhesive layer or a release coating on the other side of the backing material. The backing material is made of paper or home compostable and biodegradable polymer film, and the pressure-sensitive adhesive layer is made from an aqueous polyurethane dispersion pressure-sensitive adhesive. At least 60% by weight of the polyurethane is composed of diisocyanates, polyesterdiols, and at least one bifunctional carboxylic acid selected from di hydroxy carboxylic acids and diamino carboxylic acids, wherein the polyurethane has no melting point above 20° C. or wherein the polyurethane has a melting point above 20° C. with an enthalpy of fusion lower than 10 J/g, and wherein a film of the polyurethane adhesive preferably decomposes at home compost conditions to more than 90% by weight into CO₂ and water within 360 days.

The invention relates to adhesive labels comprising an aqueous polyurethane dispersion pressure-sensitive adhesive. The polyurethane adhesive is preferably biodegradable to the extent that it decomposes at home compost conditions to more than 90% by weight into CO₂ and water within 360 days.

An increasing demand for more sustainable solutions is currently observed in the packaging and labeling industry. Products with relatively short lifetime like labels for flexible packaging shall be compostable, especially under home compost conditions. To be fully degradable, all layers, including the adhesive and also the label substrates should be compostable. Especially in labels, the usual adhesives are highly developed pressure sensitive adhesives typically based on polyacrylates, which are typically not biodegradable or compostable.

There is high demand for biodegradable labeled packaging, which can be disposed of by composting after use.

The major challenge consists in providing adhesive materials which have the necessary functionality and stability during their lifetime but which when subject to stimulation from a bioactive environment, are degraded or decomposed with high rapidity and to a high extent. The trigger for the degradation process can be microbiological, hydrolytic, or oxidative degradation at a specific site within the main chain of an adhesive polymer. All of the degradation products should exhibit maximum safety and minimum toxicity and without accumulation within the natural environment, and this means that they should ideally be subject to preferably complete and final microbial degradation. The adhesive used for the adhesive-bonding of labels to packaging material also has an effect on biodisintegratability of the labels and the packaging. The adhesive is intended firstly to provide a stable adhesive bond between label and packaging but secondly also to promote degradability after its ordinary use lifetime. It is extremely difficult to achieve simultaneous compliance with, and optimization of, these fundamentally contradictory requirements of stability and sufficient adhesive bond strength of the adhesive before and during use and ease of degradation after use.

Non-aqueous biodegradable adhesives based on polyurethanes are described in WO 2015/091325, WO 2015/189323 and EP 3257882. For environmental and sustainability reason there is a demand for aqueous adhesive systems as substitutes for non-aqueous, organic solvent based adhesives. For increased ease of application there is a demand for aqueous adhesive systems as substitutes for non-aqueous, solventless hot melt adhesives.

WO 2012/013506 describes the use of an aqueous polyurethane dispersion adhesive for making biodisintegratable composite foils, wherein at least two substrates are adhesively bonded by use of the aqueous polyurethane dispersion adhesive and wherein at least one of the substrates is a biodisintegratable polymer foil. The polyurethane is made of at least 60% by weight of diisocyanates, polyesterdiols and at least one bifunctional carboxylic acid selected from dihydroxy carboxylic acids and diamino carboxylic acids. The biodisintegratability described in WO 2012/013506 remains unsatisfactory in some aspects. Although the complete biological degradation of the laminates is well achieved under composting conditions including composting temperature above 50° C., which are typical for conditions in industrial composting facilities, the biological degradation into carbon dioxide and water is much slower under home composting conditions, e.g. in a private gardens, where temperatures above 50° C. are typically not achieved.

Although it is known that the ester bonds in polyester polyurethanes may promote degradation by hydrolyzing due to reaction with water, a problem of contradictory requirements had to be solved. The adhesive polymer should be sufficiently stable against hydrolysis by reaction with water during manufacturing and storing of the aqueous polymer dispersion (which inherently comprises high amounts of water) but the adhesive polymer should undergo rapid degradation under home compost conditions. And the polymer adhesive should have sufficient tackiness (e.g. .measured as loop tack) and sufficient adhesion to be used as pressure-sensitive adhesive for labeling purposes.

Therefore, a problem to be solved was providing further materials for biodegradable or home compostable label adhesives, where these adhesives are water based with high stability, can be easily produced, have high quality of tackiness and adhesive properties, and also simultaneously have rapid biodisintegratability under home composting conditions, i.e. below 50° C., e.g. at 25±5° C. It has been found that the problem can be solved by the adhesive labels described below.

The invention provides adhesive labels comprising a backing material having a first side and a second side, a pressure-sensitive adhesive layer attached to the first side of the backing material and either a release liner attached to the adhesive layer or a release coating on the second side of the backing material (linerless label),

wherein the backing material is made of paper or home compostable polymer film, and the pressure-sensitive adhesive layer is made from an aqueous polyurethane dispersion pressure-sensitive adhesive,
where at least 60% by weight of the polyurethane is composed of
(a) at least one diisocyanate,
(b) at least one polyesterdiol, and
(c) at least one bifunctional carboxylic acid selected from dihydroxy carboxylic acids and diamino carboxylic acids;
   wherein the polyurethane has a glass transition temperature below 20° C.,
   characterized in that the polyurethane either has no melting point above 20° C. or wherein the polyurethane has a melting point above 20° C. with an enthalpy of fusion lower than 10 J/g.

Preferably, a film of the polyurethane adhesive is biodegradable to the extent that it decomposes at home compost conditions (25±5° C.) to more than 90% by weight into CO₂ and water within 360 days.

Preferably, a film of the polyurethane adhesive and the backing material are home compostable.

A material is home compostable if it is biodisintegratable at home compost conditions (ambient temperature of 25±5° C.) and if it decomposes at home compost conditions to more than 90% by weight into CO₂ and water within 360 days (based on Australian Standard® AS 5810-2010 “Biodegradable plastics—Biodegradable plastics suitable for home composting”).

Decomposition into CO2 can be determined by aerobic degradation according to ISO 14855-1 (2012) in a controlled composting test but at ambient temperature (25±5° C.) to simulate home composting conditions instead of the prescribed temperature of 58° C., typical to simulate composting conditions in industrial composting facilities.

A material is biodisintegratable at home compost conditions if at most 10% of the original dry weight of the material is found to be present after aerobic composting for a period of at most 180 days in a sieve fraction>2 mm in a disintegration test environment at ambient temperature (25±5° C.). Biodisintegration can be tested according to ISO 20200, but at 25±5° C. for simulating home compost conditions.

The rate of biological degradation can be determined by quantitative analysis of the produced carbon dioxide.

Biodegradability is the ability of organic substances to be broken down by micro-organisms in the presence of oxygen (aerobic) to carbon dioxide, water, biomass and mineral salts or other elements that are present (mineralization). Composting is the aerobic degradation of organic matter to make compost. Home compost is the product of privately generated organic waste, such as food, garden and paper product waste, which has been subjected to composting, and which product is applied to private property soils, typically without commercial transactions.

The invention also provides the use of an aqueous polyurethane dispersion pressure-sensitive adhesive for making an adhesive label, comprising a backing material having a first side and a second side, a pressure-sensitive adhesive layer attached to the to the first side of the backing material and either a release liner attached to the adhesive layer or a release coating on the second side of the backing material (linerless label), wherein the backing material is made of paper or of home compostable polymer film, and

the pressure-sensitive adhesive layer is made from an aqueous polyurethane dispersion pressure-sensitive adhesive,
where at least 60% by weight of the polyurethane is composed of
(a) at least one diisocyanate,
(b) at least one polyesterdiol, and
(c) at least one bifunctional carboxylic acid selected from dihydroxy carboxylic acids and diamino carboxylic acids;
   wherein the polyurethane has a glass transition temperature below 20° C.,
   characterized in that the polyurethane either has no melting point above 20° C. or wherein the polyurethane has a melting point above 20° C. with an enthalpy of fusion lower than 10 J/g.

Preferably, a film of the polyurethane adhesive decomposes at home compost conditions to more than 90% by weight into CO₂ and water within 360 days.

It was found in particular, that preferred amorphous polyester polyurethanes with high amounts of polyesterols (>80 wt. %, based on the total weight of the polyurethane), low isocyanate content (<20 wt. % isocyanate compounds, based on the total weight of the polyurethane), low amount of urea (<100 mmol/kg urea-groups) are particularly well suited to be compostable under home compost conditions and the dried films are tacky and can act particularly well as pressure sensitive adhesives, due to the low urethane contents.

Glass transition temperatures are determined by Differential Scanning calorimetry (ASTM D 3418-08, “midpoint temperature” of second heating curve, heating rate 20 K/min).

The adhesive to be used in the invention contains (preferably consists essentially of) at least one polyurethane dispersed in water as polymeric binder, and optionally of added substances, such as fillers, thickeners, antifoam, etc. The polymeric binder preferably takes the form of dispersion in water or else in a mixture made of water and of water-soluble organic solvents with boiling points which are preferably below 150° C. (1 bar). Particular preference is given to water as sole solvent. The water or other solvents are not included in the calculation of weight data relating to the constitution of the adhesive.

The polyurethanes are preferably mainly composed of aliphatic polyisocyanates, in particular diisocyanates, on the one hand, and on the other hand of reactants which are preferably non-crystalline polyesterdiols, and also bifunctional carboxylic acids. It is preferable that the polyurethane is composed of at least 60% by weight, and very particularly at least 80% by weight, of diisocyanates, polyesterdiols, and bifunctional carboxylic acids.

The polyurethane is preferably amorphous. It is preferable that the polyurethane comprises an amount of more than 10% by weight, more than 50% by weight, or at least 80% by weight, based on the polyurethane, of aliphatic polyesterdiols.

The polyesterdiol preferably is either made of at least one diacid and at least one branched diol or the polyesterdiol is liquid below 60° C. The polyesterdiols are preferably made of at least 10 mol %, preferably at least 20 mol % or at least 30 mol % of branched aliphatic diols, based on the sum of diols used for making the polyesterdiol. Preferred branched aliphatic diols are neopentyl glycol, 3-methyl pentanediol, 2-methyl propanediol and hydroxypivalic acid neopentyl glycolester (3-hydroxy-2,2-dimethylpropyl 3-hydroxy-2,2-dimethylpropanoate). Most preferred branched aliphatic diol is neopentyl glycol.

Examples of polyesterdiols liquid below 60° C. are made from a diacid and mixtures of at least two different aliphatic diols, wherein at least one diol contains heteroatoms in the chain; e.g. ethylene glycol, diethylene glycol, polyethylene glycols or polytetrahydrofuran. Preferred liquid polyesterdiols are made from at least one diacid selected from adipic acid, succinic acid and sebacic acid and ethylene glycol and diethylene glycol.

The polyurethane is preferably composed of:
a) at least one diisocyanate, which preferably are aliphatic or cycloaliphatic,
b) at least one diol, where, of these,
   b1) from 10 to 100 mol %, based on the total amount of the diols (b), are polyesterdiols with a molar mass of from 500 to 5000 g/mol,
   b2) from 0 to 90 mol %, based on the total amount of the diols (b), have a molar mass of from 60 to 500 g/mol,
c) at least one bifunctional carboxylic acid selected from dihydroxycarboxylic acids and diaminocarboxylic acids,
d) optionally other polyfunctional compounds which differ from the monomers (a) to (c) and which have reactive groups, where these are alcoholic hydroxy groups, primary or secondary amino groups, or isocyanate groups, and
e) optionally monofunctional compounds which differ from the monomers (a) to (d) and which have a reactive group which is an alcoholic hydroxy group, a primary or secondary amino group, or an isocyanate group.

Also preferred is a polyurethane which is composed of at least 60% by weight of
(a) at least one aliphatic diisocyanate,
(b) at least one aliphatic polyesterdiol,
(c) at least one bifunctional carboxylic acid selected from dihydroxycarboxylic acids and diaminocarboxylic acids, and
(d) at least one polyfunctional compound which differs from the monomers (a) to (c) and which has at least two reactive groups selected from primary and secondary amino groups.

Preferably, at least 80% by weight of the at least one polyesterdiol (b) is composed of at least one aliphatic dicarboxylic acid and of at least one aliphatic diol.

Monomers (a) that should particularly be mentioned are diisocyanates X(NCO)₂, where X is an aliphatic hydrocarbon radical having from 4 to 15 carbon atoms or a cycloaliphatic or aromatic hydrocarbon radical having from 6 to 15 carbon atoms, or an araliphatic hydrocarbon radical having from 7 to 15 carbon atoms, wherein the aliphatic and/or cycloaliphatic diisocyanates are preferred. Examples of these diisocyanates are tetramethylene diisocyanate, hexamethylene diisocyanate, dodecamethylene diisocyanate, 1,4-diisocyanatocyclohexane, 1-isocyanato-3,5,5-trimethyl-3-isocyanatomethylcyclohexane (IPDI), 2,2-bis(4-isocyanatocyclohexyl)propane, trimethylhexane diisocyanate, the isomers of bis(4-isocyanatocyclohexyl)methane (HMDI), e.g. the trans/trans, the cis/cis, and the cis/trans isomers, and also mixtures composed of said compounds. Examples of aromatic diisocyanates are 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI). Diisocyanates of this type are available commercially.

Mixtures of said isocyanates are for example the mixtures of the respective structural isomers of diisocyanatotoluene and diisocyanatodiphenylmethane, e.g. a mixture made of 80 mol % of 2,4-diisocyanatotoluene and 20 mol % of 2,6-diisocyanatotoluene; or mixtures of aromatic isocyanates such as 2,4-diisocyanatotoluene and/or 2,6-diisocyanatotoluene with aliphatic or cycloaliphatic isocyanates such as hexamethylene diisocyanate or IPDI, where the preferred mixing ratio of the aliphatic to aromatic isocyanates is from 4:1 to 1:4. Most preferred is hexamethylene diisocyanate.

Other than the abovementioned compounds, other compounds that can be used in the structure of the polyurethanes are those which have, alongside the free isocyanate groups, other capped isocyanate groups, e.g. uretdione groups.

With a view to good film-formation and elasticity, diols (b) that can be used are mainly relatively high-molecular-weight diols (b1) which have a molar mass of about 500 to 5000 g/mol, preferably about 1000 to 3000 g/mol. This is the number-average molar mass Mn. Mn is calculated by determining the number of terminal groups (OH number).

The diols (b1) can be polyester polyols, where these are known by way of example from Ullmanns Enzyklopädie der technischen Chemie [Ullmann's encyclopedia of industrial chemistry], 4th edition, volume 19, pp. 62 to 65. It is preferable to use polyester polyols which are obtained via reaction of difunctional alcohols with difunctional carboxylic acids. Instead of the free polycarboxylic acids, it is also possible to use the corresponding polycarboxylic anhydrides or corresponding polycarboxylic esters of lower alcohols, or a mixture of these, to produce the polyester polyols. The polycarboxylic acids can be aliphatic, cycloaliphatic, araliphatic, aromatic, or heterocyclic, and can optionally have unsaturation and/or substitution, e.g. by halogen atoms. Examples that may be mentioned of these are: suberic acid, azelaic acid, phthalic acid, isophthalic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, and dimeric fatty acids. Preference is given to dicarboxylic acids of the general formula HOOC—(CH2)_{y}-COOH, where y is a number from 1 to 20, preferably an even number from 2 to 20, examples being succinic acid, adipic acid, sebacic acid, and dodecane dicarboxylic acid.

Examples of polyfunctional alcohols that can be used are ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes, such as 1,4-bis(hydroxymethyl)cyclohexane, 2-methyl-propane-1,3-diol, methylpentanediols (for example 3-methyl pentanediol), hydroxypivalic acid neopentyl glycolester (3-hydroxy-2,2-dimethylpropyl 3-hydroxy-2,2-dimethylpropanoate) and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ-OH, where x is a number from 1 to 20, preferably an even number from 2 to 20, in mixture with branched aliphatic diols, especially neopentyl glycol, wherein the amount of branched aliphatic diols is preferably at least 10 mol %, at least 25 mol % or at least 30 mol % of the total amount of diols.

It is optionally also possible to use polycarbonatediols as by way of example are obtainable via reaction of phosgene with an excess of the low-molecular-weight alcohols mentioned as structural components for the polyester polyols.

It is also possible to use lactone-based polyesterdiols, alone or in combination with the above-mentioned polyesterdiols, where these are homo- or copolymers of lactones, preferably adducts which have terminal hydroxy groups and which are produced by addition reactions of lactones onto suitable difunctional starter molecules. Preferred lactones that can be used are those deriving from compounds of the general formula HO—(CH₂)₂-COOH, where z is a number from 1 to 20 and an H atom of a methylene unit can also have been replaced by a C₁-C₄-alkyl radical. Examples are epsilon-caprolactone, β-propiolactone, gamma-butyrolactone, and/or methyl-epsilon-caprolactone, and also mixtures of these. Examples of suitable starter components are the low-molecular-weight difunctional alcohols mentioned above as structural component for the polyester polyols. Particular preference is given to the corresponding polymers of epsilon-caprolactone. Lower polyesterdiols or polyetherdiols can also be used as starters for producing the lactone polymers. Instead of the polymers of lactones, it is also possible to use the corresponding, chemically equivalent polycondensates of the hydroxycarboxylic acids that correspond to the lactones.

In addition to the polyesterdiols, it is also optionally possible to make concomitant use of polyetherdiols. Polyetherdiols are in particular obtainable via polymerization of ethylene oxide, propylene oxide, butylene oxide, tetrahydrofuran, styrene oxide, or epichlorohydrin with themselves, e.g. in the presence of BF₃, or via an addition reaction of said compounds, optionally in a mixture or in succession, onto starter components having reactive hydrogen atoms, e.g. alcohols or amines, examples being water, ethylene glycol, propane-1,2-diol, propane-1,3-diol, 2,2-bis(4-hydroxyphenyl)propane, or aniline. Examples of polyetherdiols are polypropylene oxide and polytetrahydrofuran with molar mass from 240 to 5000 g/mol, and especially from 500 to 4500 g/mol. However, it is preferable that no polyetherdiols are used as structural component for the polyurethanes.

It is also optionally possible to make concomitant use of polyhydroxyolefins, preferably those having 2 terminal hydroxy groups, e.g. α,ω-dihydroxypolybutadiene, α,ω-dihydroxypolymethacrylate, or α,ω-dihydroxypolyacrylate. Other suitable polyols are polyacetals, polysiloxanes, and alkyd resins.

It is preferable that at least 95 mol % or 100 mol % of the diols b₁) are polyesterdiols. It is particularly preferable that diols b₁) used comprise exclusively polyesterdiols. The polyesterdiols preferably consist of only aliphatic and/or cycloaliphatic components.

Preferably, the polyurethane is made of at least 50% by weight, more preferably of at least 85% by weight or of at least 95% by weight or of 100% by weight, based on all polyhydroxy compounds, of polyesterdiols.

The hardness and the modulus of elasticity of the polyurethanes can be increased if diols (b) used also comprise, alongside the diols (b₂), low-molar-mass diols (b₂) with molar mass about 60 to 500 g/mol, preferably from 62 to 200 g/mol. Monomers (b2) used are especially the structural components of the short-chain alkanediols mentioned for the production of polyester polyols, where preference is given to the unbranched diols having from 2 to 12 carbon atoms and having an even number of carbon atoms, and also pentane-1,5-diol and neopentyl glycol.

Examples of diols b₂) that can be used are ethylene glycol, propane-1,2-diol, propane-1,3-diol, butane-1,3-diol, butene-1,4-diol, butyne-1,4-diol, pentane-1,5-diol, neopentyl glycol, bis-(hydroxymethyl)cyclohexanes, such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ-OH, where x is a number from 1 to 20, preferably an even number from 2 to 20. Examples here are ethylene glycol, butane-1,4-diol, hexane-1,6-diol, octane-1,8-diol, and dodecane-1,12-diol. Preference is further given to neopentyl glycol.

It is preferable that the proportion of the diols (b₁), based on the total amount of the diols (b), is from 10 to 100 mol % or from 60 to 100 mol %, and that the proportion of the monomers (b₂), based on the total amount of the diols (b), is from 0 to 90 mol %, or from 0 to 40 mol %.

In order to achieve the water-dispersibility of the polyurethanes and to improve biodegradability, the polyurethanes comprise at least one bifunctional carboxylic acid selected from dihydroxycarboxylic acids and diaminocarboxylic acids. It is optionally also possible to make additional use of hydrophilic structural components which promote dispersibility and which bear at least one isocyanate group or at least one group reactive toward isocyanate groups, and moreover at least one hydrophilic group, or one group which can be converted to a hydrophilic group. In the text hereinafter, the “hydrophilic groups or potentially hydrophilic groups” is abbreviated to “(potentially) hydrophilic groups”. When compared with the functional groups of the monomers that are used to construct the main chain of the polymer, the (potentially) hydrophilic groups are substantially slower to react with isocyanates.

The proportion of the components having (potentially) hydrophilic groups, based on the total amount of components (a) to (e), is generally judged in such a way that the molar amount of the (potentially) hydrophilic groups, based on the total amount of all of the monomers (a) to (e), is from 30 to 1000 mmol/kg, preferably from 50 to 500 mmol/kg, and particularly preferably from 80 to 300 mmol/kg. The (potentially) hydrophilic groups can be nonionic or preferably (potentially) ionic hydrophilic groups. Particular nonionic hydrophilic groups that can be used are in the form of polyethylene glycol ethers preferably made of from 5 to 100 repeat ethylene oxide units, with preference from 10 to 80 repeat ethylene oxide units. The content of polyethylene oxide units is generally from 0 to 10% by weight, preferably from 0 to 6% by weight, based on the total amount of all of the monomers (a) to (e). Examples of monomers having nonionic hydrophilic groups are polyethylene oxide diols using at least 20% by weight of ethylene oxide, polyethylene oxide monools, and also the reaction products of a polyethylene glycol and of a diisocyanate, where these bear an etherified terminal polyethylene glycol radical. Diisocyanates of this type, and also processes for their production, are given in the patent specifications U.S. Pat. No. 3,905,929 and U.S. Pat. No. 3,920,598.

The bifunctional carboxylic acid used usually comprises aliphatic, cycloaliphatic, araliphatic, or aromatic carboxylic acids, where these bear at least two hydroxy groups or two primary or secondary amino groups. Preference is given to dihydroxyalkylcarboxylic acids, especially those having from 3 to 10 carbon atoms, as are also described in U.S. Pat. No. 3,412,054. Particular preference is given to compounds of the general formula (c₁)

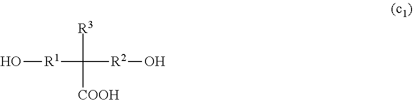

in which R¹ and R² are a C₁-C₄-alkanediyl group, and R³ is a C₁-C₄-alkyl group, and especially to dimethylolpropionic acid (DMPA).

Monomers (c) which can be used and which have amino groups reactive toward isocyanates are diaminocarboxylic acids, or the adducts which are mentioned in DE-A 2034479 and which derive from an addition reaction of aliphatic diprimary diamines onto alpha,beta-unsaturated carboxylic acids. Compounds of this type comply by way of example with the formula (c₂)

H₂N—R⁴—NH—R⁵—X (c₂)

where R⁴ and R⁵, independently of one another, are a C₁-C₆-alkanediyl group, preferably ethylene, and X is COOH. Particularly preferred compounds of the formula (c₂) are N-(2-aminoethyl)-2-aminoethanecarboxylic acid and the corresponding alkali metal salts, where Na is particularly preferred as counterion.

Alongside the bifunctional carboxylic acids, other monomers having hydrophilic groups can optionally also be used, examples being appropriate dihydroxysulfonic acids and dihydroxyphosphonic acids, such as 2,3-dihydroxypropanephosphonic acid, or diaminosulfonic acids. However, it is preferable not to use any bifunctional sulfonic acids or phosphonic acids.

Ionic hydrophilic groups are especially anionic groups such as the sulfonate group, the carboxylate group, and the phosphate group, in the form of their alkali metal salts or ammonium salts, and also cationic groups, such as ammonium groups, in particular protonated tertiary amino groups, or quaternary ammonium groups. Potentially ionic hydrophilic groups are especially those which can be converted into the abovementioned ionic hydrophilic groups via simple neutralization, hydrolysis, or quaternization reactions, therefore being by way of example carboxylic acid groups or tertiary amino groups. (Potentially) ionic monomers are described by way of example in Ullmanns Enzyklopädie der technischen Chemie [Ullmann's encyclopedia of industrial chemistry], 4^{th} edition, volume 19, pp. 311-313, and by way of example in DE-A 1 495 745, in detail.

(Potentially) cationic monomers (c) that are of particular practical importance are especially monomers having tertiary amino groups, examples being: tris(hydroxyalkyl)amines, N,N′-bis-(hydroxyalkyl)alkylamines, N-hydroxyalkyl dialkylamines, tris(aminoalkyl)amines, N,N′-bis-(aminoalkyl)alkylamines, and N-aminoalkyl dialkylamines, where the alkyl radicals and alkanediyl units of said tertiary amines are composed independently of one another of from 1 to 6 carbon atoms. Other compounds that can be used are polyethers having tertiary nitrogen atoms and preferably having two terminal hydroxy groups, for example those accessible in a manner which is conventional per se via alkoxylation of amines having two hydrogen atoms bonded to amine nitrogen, e.g. methylamine, aniline, or N,N′-dimethylhydrazine. The molar mass of polyethers of this type is generally from 500 to 6000 g/mol. Said tertiary amines are converted to the ammonium salts either with acids, preferably strong mineral acids, such as phosphoric acid, sulfuric acid, hydrohalic acids, or strong organic acids, or via reaction with suitable quaternizing agents, such as C₁-C₆-alkyl halides or benzyl halides, e.g. bromides or chlorides.

To the extent that monomers having potentially ionic groups are used, the conversion of these to the ionic form can take place prior to, during, or preferably after the isocyanate polyaddition reaction, since the ionic monomers are often only sparingly soluble in the reaction mixture. It is particularly preferable that the carboxylate groups are present in the form of their salts with an alkali metal ion or ammonium ion as counterion.

The monomers (d) which differ from the monomers (a) to (c) and which optionally are also constituents of the polyurethane are generally used for crosslinking or for chain extension. They are generally nonphenolic alcohols of functionality more than two, amines having 2 or more primary and/or secondary amino groups, or else compounds which have not only one or more alcoholic hydroxy groups but also one or more primary and/or secondary amino groups. Examples of alcohols which have functionality higher than 2 and which can be used to adjust to a certain degree of branching or of crosslinking are trimethylolpropane, glycerol, or sugars. Monoalcohols can also be used where these bear not only the hydroxy group but also another group reactive toward isocyanates, examples being monoalcohols having one or more primary and/or secondary amino groups, e.g. monoethanolamine.

Polyamines having 2 or more primary and/or secondary amino groups are used especially when the chain extension and, respectively, crosslinking reaction is intended to take place in the presence of water, since the speed of reaction of amines with isocyanates is generally greater than that of alcohols or water. This is frequently a requirement when aqueous dispersions of crosslinked polyurethanes or polyurethanes with high molecular weight are desired. In such cases, the procedure is to produce prepolymers having isocyanate groups, to disperse these rapidly in water, and then to subject them to chain-extension or crosslinking via addition of compounds having a plurality of amino groups reactive toward isocyanates. Amines suitable for this purpose are generally polyfunctional amines in the molar-mass range from 32 to 500 g/mol, preferably from 60 to 300 g/mol, where these comprise at least two amino groups selected from the group of the primary and secondary amino groups. Examples here are diamines, such as diaminoethane, diaminopropanes, diaminobutanes, diaminohexanes, piperazine, 2,5-dimethylpiperazine, 1-amino-3-(aminomethyl)-3,5,5-trimethylcyclohexane (isophoronediamine, IPDA), 4,4′-diaminodicyclohexylmethane, 1,4-diaminocyclohexane, aminoethyl ethanolamine, hydrazine, hydrazine hydrate, or triamines, such as diethylenetriamine or 1,8-diamino-4-aminomethyloctane.

The amines can also be used in capped form, e.g. in the form of the corresponding ketimines (see, for example, CA-A 1 129 128), ketazines (cf., for example, U.S. Pat. No. 4,269,748), or amine salts (see U.S. Pat. No. 4,292,226). Oxazolidines, for example those used in U.S. Pat. No. 4,192,937, are also capped polyamines which can be used for producing the polyurethanes of the invention, for purposes of chain-extension of the prepolymers. When capped polyamines of this type are used, they are generally mixed with the prepolymers in the absence of water, and this mixture is then mixed with the dispersion water or with a portion of the dispersion water, so that the corresponding polyamines are liberated by hydrolysis.

It is preferable to use mixtures of di- and triamines, and it is particularly preferable to use mixtures of isophoronediamine (IPDA) and diethylenetriamine (DETA).

The polyurethanes preferably comprise, as monomers (d), from 1 to 30 mol %, particularly from 4 to 25 mol %, based on the total amount of functional groups of monomers reactive towards isocyanates, of a polyamine having at least 2 amino groups reactive toward isocyanates. It is also possible to use, as monomers (d) for the same purpose, isocyanates of functionality higher than two. Examples of compounds available commercially are the isocyanurate or the biuret of hexamethylene diisocyanate.

Monomers (e) which are optionally used concomitantly are monoisocyanates, monoalcohols, and monoprimary and -secondary amines. The proportion of these is generally at most 10 mol %, based on the total molar amount of the monomers. Said monofunctional compounds usually bear other functional groups, examples being olefinic groups or carbonyl groups, and are used to introduce functional groups into the polyurethane, where these permit the dispersion and, respectively, the crosslinking or further polymer-analogous reaction of the polyurethane. Monomers that can be used for this purpose are those such as isopropenyl-α,α-dimethylbenzyl isocyanate (TMI) and esters of acrylic or methacrylic acid, e.g. hydroxyethyl acrylate or hydroxyethyl methacrylate.

Preferably, the polyurethane consists to at least 50% by weight, more preferably to at least 80% by weight, or to at least 90% by weight of, based on the sum of all monomers, of diisocyanates (a), diols (b) and bifunctional carboxylic acids (c).

The total amount of monomers (d) and (e) is preferably up to or less than 10% by weight, for example 0.1 to 10% by weight or 0.5 to 5% by weight.

Adhesive with particularly good property profile are especially obtained if monomers (a) used are in essence only aliphatic diisocyanates, cycloaliphatic diisocyanates, or araliphatic diisocyanates. Preferably said monomer combination is complemented by, as component (c), alkali-metal salts of dihydroxy- or diamino monocarboxylic acid; the Na salt is most suitable here.

Most preferred are components (a) to (e) which result in a polyurethane with a glass transition temperature of less than 20° C. and either no melting point above 20° C. or wherein the polyurethane has a melting point above 20° C. with an enthalpy of fusion lower than 10 J/g.

The method for adjusting the molecular weight of the polyurethanes via selection of the proportions of the mutually reactive monomers, and also of the arithmetic average number of reactive functional groups per molecule, is well known in the polyurethane chemistry sector. The normal method selects components (a) to (e), and also the respective molar amounts of these, in such a way that the ratio A:B, where
A is the molar amount of isocyanate groups and
B is the sum of the molar amount of the hydroxy groups and of the molar amount of the functional groups which can react with isocyanates in an addition reaction, can be from 0.5:1 to 2:1, from 0.8:1 to 1.5:1, or from 0.9:1 to 1.2:1.

The ratio A:B of isocyanate groups to groups reactive with isocyanates is preferably at least 1:1 or higher than 1:1, e.g. up to 2:1, or up to 1.5:1 or up to 1.2:1, most preferred as close as possible to 1:1, so that the polyurethane has no pending NCO-reactive groups (such as pending hydroxy groups).

The monomers (a) to (e) used usually bear an average of from 1.5 to 2.5, preferably from 1.9 to 2.1, particularly preferably 2.0, isocyanate groups and, respectively, functional groups which can react with isocyanates in an addition reaction.

For sustainability reasons it is preferred to use bio-based materials for producing the polyurethane adhesives. The term “bio-based” indicates that the material is of biological origin and comes from a biomaterial/renewable resources. A material of renewable origin or biomaterial is an organic material wherein the carbon comes from the CO₂ fixed recently (on a human scale) by photosynthesis from the atmosphere. A biomaterial (carbon of 100% natural origin) has an isotopic ratio ¹⁴C/¹²C greater than 10⁻¹², typically about 1.2×10⁻¹², while a fossil material has a zero ratio. Indeed, the isotopic ¹⁴C is formed in the atmosphere and is then integrated via photosynthesis, according to a time scale of a few tens of years at most. The half-life of the ¹⁴C is 5,730 years. Thus, the materials coming from photosynthesis, namely plants in general, necessarily have a maximum content in isotope ¹⁴C. The determination of the content of biomaterial or of bio-carbon can be carried out in accordance with the standards ASTM D 6866-12, the method B (ASTM D 6866-06) and ASTM D 7026 (ASTM D 7026-04). Suitable bio-based materials for producing polyurethanes are for example alcohols (in particular diols and polyols) and organic acids (in particular diacids) derived from natural materials such as starch, saccharose, glucose, lignocellulose, natural rubber or plant oils. Suitable alcohols and organic acids derived from natural materials are for example ethanol, monoethylene glycol, polyethylene glycol, isosorbide, 1,3-propanediol, 1,4-butanediol, glycerol, adipic acid or succinic acid. Preferably at least part of the polyurethane is made of bio-based materials.

The polyaddition reaction of the structural components used to produce the polyurethane preferably takes place at reaction temperatures of up to 180° C., with preference up to 150° C., at atmospheric pressure or at autogenous pressure. The production of polyurethanes and, respectively, of aqueous polyurethane dispersions is known to the person skilled in the art. The polyurethanes preferably take the form of aqueous dispersion and are used in this form. The pH of the polymer dispersion is preferably adjusted to pH above 5, in particular to pH from 5.5 to 10.5.

The adhesive to be used in the invention comprises carboxylate groups and preferably other reactive groups, where these can enter into a crosslinking reaction with one another or with external crosslinking agents. The amount of said reactive groups preferably present is from 0.0001 to 0.5 mol/100 g of adhesive, particularly from 0.0005 to 0.5 mol/100 g of adhesive. Carboxy groups are also formed via hydrolysis reactions, and it is therefore also possible that crosslinking can occur without any initial content of carboxy groups in the polyurethane.

In one aspect of the invention, the polyurethane dispersion adhesive of the invention is used as single-component composition, i.e. without additional crosslinking means, in particular without isocyanate crosslinking agent. However, the polyurethane dispersion adhesive of the invention can also be used as two-component adhesive comprising the polyurethane dispersion in one component and at least one external crosslinking agent, e.g. a water-emulsifiable isocyanate, in a separate component, and adding the crosslinking component shortly before application of the adhesive. A two-component composition is a product consisting of two separately packaged compositions which are mixed shortly before its use.

Examples of suitable crosslinking agents are polyisocyanates having at least two isocyanate groups, e.g. isocyanurates formed from diisocyanates, compounds having at least one carbodiimide group, chemically capped isocyanates, encapsulated isocyanates, encapsulated uretdiones, biurets, or allophanates. Aziridines, oxazolines, and epoxides are also suitable. The amount used of the external crosslinking agent is preferably from 0.5 to 10% by weight, based on the solids content of the dispersion. An external crosslinking agent is a compound which, prior to the crosslinking reaction, has not been bonded to the polyurethane but instead has been dispersed or dissolved in the polyurethane dispersion. However, it is also possible to use crosslinking agents which have been bonded to the polyurethane (internal crosslinking agents).

Preferred polyurethane adhesives

are made of high amounts of polyesterols (>80 wt. %, based on the total weight of the polyurethane);
have low isocyanate content of <20 wt. % isocyanate compounds, based on the total weight of the polyurethane); and
have low amounts of urea groups of <100 mmol/kg.

The inventive adhesive labels are self-adhesive. The backing material is preferably selected from paper or a thermoplastic film. The backing material is preferably home compostable and/or biodegradable. Biodegradable backing material include polylactic acid, cellulose, modified starch, polyhydroxyalkanoates, and biodegradable polyesters such as polyesters based on at least one C₂- to C₁₂ alkanediol and at least one dicarboxylic acid selected from the group consisting of adipic acid, terephthalic acid, and succinic acid. Preferred biodegradable backing material are foils made of lignin, of starch, of cellulose materials, of polylactic acid (PLA), of polylactic acid stereocomplexes (PLLA-PDLA), of polyglycolic acid (PGA), of aliphatic polyesters, of aliphatic-aromatic copolyesters, and of polyhydroxyalkanoates, cellophane, polypropylene carbonate (PPC), and mixtures of the abovementioned materials. Examples of aliphatic polyesters are polybutylene succinate (PBS), polybutylene succinate-co-butylene adipate (PBSA), polybutylene succinate-co-butylene sebacate (PBSSe), polycaprolactone (PCL), and polypentadecanolide. Examples of aliphatic-aromatic copolyesters are polybutylene adipate-co-butyleneterephthalate (PBAT), polybutylene sebacate-co-butylene terephthalate (PBSeT), polybutylene azelate-co-butylene terephthalate (PBAzeT), polybutylene brassylate-co-butylene terephthalate (PBBrasT). Examples of particularly suitable materials are Ecoflex® foils, e.g. Ecoflex® F or Ecoflex® FS. Examples of polyhydroxyalkanoates are poly-3-hydroxy-butyrate (PHB), poly-3-hydroxybutyrate-co-3-hydroxyvalerate (P(3HB)-co-P(3HV)), poly-3-hydroxybutyrate-co-4-hydroxybutyrate (P(3HB)-co-P(4HB)), poly-3-hydroxybutyrate-co-3-hydroxyhexanoate (P(3HB)-co-P(3HH)).

With particular preference the biodegradable backing material is paper or consists to an extent of at least 95 wt. %, more particularly at least 98 wt. %, very preferably 100 wt. %, based in each case on the total weight of the biodegradable backing, of polylactic acid, lignin, starch, cellulose materials, polyglycolic acid, polyhydroxyalkanoates, polypropylene carbonate, aliphatic polyesters such as for example polybutylene succinate, aliphatic-aromatic copolyesters such as for example butanediol-adipic acid-terephthalic acid copolymer, or a blend of a butanediol-adipic acid-terephthalic acid copolymer and polylactic acid and mixtures of the abovementioned materials.

The side of the backing material coated with pressure-sensitive adhesive may be covered with a release liner, for example with a siliconized paper, until later use. Materials of the release liner can be polyethylene, polypropylene, multilayer laminated polypropylene/polyethylene films, polyester or paper that is single-sidedly or double-sidedly coated with silicone (siliconized paper). Linerless labels can be made without a release liner and comprise a release coating (for example a silicone coating) on the second side of the backing material (the side not coated with the adhesive layer).

The release liner is intended to remain on the adhesive label until the label is applied to a substrate. The surface energy of the release liner or the surface energy of the release coating is preferably less than 30 mN/m.

A preferred adhesive label (without the release liner) is home compostable, wherein a material is home compostable if it is biodisintegratable at home compost conditions (25±5° C.) and if it decomposes at home compost conditions to more than 90% by weight into CO₂ and water within 360 days; and

wherein a material is biodisintegratable at home compost conditions if at most 10% of the original dry weight of the material is found to be present after aerobic composting at 25±5° C. for a period of at most 180 days in a sieve fraction>2 mm.

The substrates to which the self-adhesive labels may advantageously be applied may be metal, wood, glass, paper or plastic for example. The self-adhesive labels are especially suitable for bonding to packaging surfaces, cardboard boxes, plastic packaging, books, windows, vapor barriers, motor vehicle bodies, tires or vehicle body parts.

The aqueous polyurethane adhesive dispersions here can be used without further additives or after further formulation with conventional auxiliaries. Examples of conventional auxiliaries are wetting agents, thickeners, protective colloids, light stabilizers, biocides, antifoams, tackifier, plasticizer, etc. The adhesive preparations of the invention do not necessarily require the addition of plasticizing resins (tackifiers) or of other plasticizers.

The amount of polyurethane adhesive polymer in the adhesive composition is preferably from 15 to 75 wt. %, more preferred from 40 to 60 wt. %.

The amount of additives in the adhesive formulation is preferably from 0.05 to 5 parts by weight, or from 0.1 to 3 parts by weight per 100 parts by weight of adhesive polymer (based on solids).

In the invention, the aqueous polyurethane adhesive dispersions of the invention are used in aqueous adhesive preparations for producing labels, i.e. in aqueous pressure-sensitive adhesive preparations for the adhesive bonding of labels to substrates. The present invention therefore also provides a process for producing adhesive labels which preferably are biodisintegratable at home compost conditions (25±5° C.) by using an aqueous adhesive preparation which comprises at least one polyurethane polymer dispersion of the invention as described herein.

The process comprises providing an aqueous polyurethane dispersion pressure-sensitive adhesive with the polyurethane-based features as described above,

and either coating this dispersion onto a release liner; drying; and attaching a backing material to the adhesive layer; or coating the adhesive dispersion on the first side of a backing material comprising a release coating on its second side, wherein the backing preferably is biodegradable.

In the process of the invention for producing adhesive labels, the aqueous polyurethane dispersion of the invention or a corresponding further formulated preparation is applied preferably using a layer thickness of from 2 to 150 g/m², particularly preferably from 10 to 40 g/m², for example via doctoring, spreading, etc. Conventional coating processes can be used, e.g. roller coating, reverse-roll coating, gravure-roll coating, reverse-gravure-roll coating, brush coating, bar coating, spray coating, airbrush coating, meniscus coating, curtain coating, or dip coating. After a short time for air-drying of the dispersion water (preferably after from 1 to 60 seconds), the first coated substrate (e.g. the release liner) can then be laminated to a second substrate (e.g. the backing material), and the coating temperature can for example be from 20 to 200° C., preferably from 20 to 100° C. Dispersion coatings do not necessarily require heating prior to application. The web speeds can be very high: up to 3000 m/min.

The adhesive label according to the invention preferably has a loop tack of at least 3 N/25 mm, measured as described in the examples.

The adhesive label according to the invention preferably has a 90° peel adhesion of at least 3 N/25 mm, measured after 24 hours contact time as described in the examples.

An advantage of the invention is that the adhesive labels of the invention made with water-based adhesives provide good tackiness (loop tack), good peel adhesion and good biodegradability and home compostability.

### EXAMPLES

Glass transition temperatures are determined by Differential Scanning calorimetry (ASTM D 3418-08, “midpoint temperature” of second heating curve, heating rate 20 K/min).

Melting-points and enthalpy of fusion are determined according to DIN 53765 (1994) (melting point=peak temperature) by heating with 20 K/min after heating the polyurethane films to 120° C., cooling with 20 K/min to 23° C., annealing there for 20 hours.

LD values: Polymerdispersions and polymer particle sizes are characterized by the LD value of the polymer dispersion (Lichtdurchlässigkeit; light transmission), determined indirectly via turbidity measurements. For this purpose the turbidity of a dispersion having a solids content of 0.01% by weight is determined at room temperature relative to distilled water at a layer thickness of 2.5 cm.

### Example 1

483 g of a polyesterdiol made of adipic acid, 1,6-hexanediol and neopentyl glycol (molar ratio of 1,6-hexanediol:neopentyl glycol=1.8:1); OH number=56 mg KOH/g), 121.7 g of a polyester-diol made of adipic acid, ethylene-glycol and diethylene-glycol (OH number=56 mg KOH/g), 2.68 g trimethylolpropane and 13.4 g dimethylolpropionic acid (DMPA) are reacted at 95° C. in 62 g water-free acetone with 75.7 g hexamethylene diisocyanate for 2 hours. Then 130 g of water-free acetone is added and the temperature reduced to 67° C. The reaction is continued to a NCO-content of 0.28% The mixture is then diluted with 646 g of acetone and cooled to 57° C. Then 3.4 g of isophoronediamine (IPDA) diluted in 13.6 g acetone are added dropwise in 5 min and the mixture is stirred for 30 min. The mixture is neutralized with 23.8 g of a 5% strength of aqueous ammonia solution and the mixture is dispersed using 900 g of deionized water. The acetone is removed by distillation in vacuo .Solids content is adjusted to 46%.

Analysis values: LD: 82; pH: 7.4

### Example 2

604 g of a polyesterdiol made of adipic acid, 1,6-hexanediol and neopentyl glycol (OH number 56 mg KOH/g) 10 g Ymer® N120 (polyethylene glycol side chain modified diol, OH number 112 mg KOH/g; from Perstorp), 1.34 g trimethylolpropane and 13.4 g dimethylolpropionic acid (DMPA) are reacted at 95° C. in 62 g water-free acetone with 74.8 g hexamethylene diisocyanate for 1 hour. Then 130 g of water-free acetone is added and the temperature reduced to 67° C. The reaction is continued to a NCO-content of 0.22%. The mixture is then diluted with 646 g of acetone and cooled to 57° C. Then 3.4 g of isophoronediamine (IPDA) diluted in 13.6 g acetone are added dropwise in 5 min and the mixture is stirred for 30 min. The mixture is neutralized with 23.8 g of a 5% strength of aqueous ammonia solution and the mixture is dispersed using 800 g of deionized water. The acetone is removed by distillation in vacuo, and solids content is adjusted to 45%.

Analysis values: LD: 79; pH: 7.6

### Example 3

405 g of a polyesterdiol made of adipic acid, 1,6-hexanediol and neopentyl glycol (OH number 56 mg KOH/g) is reacted at 90° C. with 8.9 g of benzene tetracarboxylic acid dianhydride until the anhydride groups are consumed. The mixture is diluted with 120 g water-free acetone, cooled to 60° C. and 30.3 g hexamethylene diisocyanate diluted in 10 g water-free acetone are added and the reaction is continued at 67° C. to a NCO-content of 0.2%. The mixture is then diluted with 500 g of acetone and cooled to 33° C. Then 3.14 g of isophoronediamine (IPDA) are added dropwise and the mixture is stirred for 5 min. The mixture is neutralized with 22.1 g of a 6% strength of aqueous ammonia solution and the mixture is dispersed using 550 g of deionized water. The acetone is removed by distillation in vacuo, and solids content is adjusted to 50%.

Analysis values: LD: 23; pH: 8.2

### Example 4

608.7 g of a polyesterdiol made of adipic acid, ethylene-glycol and diethylene-glycol (OH number=56 mg KOH/g) and 13.4 g dimethylolpropionic acid (DMPA) are reacted at 94° C. in 62 g water-free acetone with 70.6 g hexamethylene diisocyanate for 4 hours. Then 130 g of water-free acetone is added over 3 h and the temperature reduced to 67° C. The reaction is continued to a NCO-content of 0.19%. The mixture is then diluted with 646 g of acetone and cooled to 57° C. 3.4 g of isophoronediamine (IPDA) diluted in 13.6 g acetone are added dropwise in 5 min and the mixture is stirred for 30 min. The mixture is neutralized with 23.8 g of a 5% strength of aqueous ammonia solution and the mixture is dispersed using 844 g of deionized water. The acetone is removed by distillation in vacuo, and solids content is adjusted to 45%.

Analysis values: LD: 48; pH: 7.5
amorphous, no melting point; Tg: −40° C.

### Example 5

604 g of a polyesterdiol made of adipic acid, 1,6-hexanediol and neopentyl glycol (OH number 56 mg KOH/g) 20 g Ymer® N120 (polyethylene glycol side chain modified diol, OH number 112 mg KOH/g; from Perstorp), 2.68 g trimethylolpropane and 13.4 g dimethylolpropionic acid (DMPA) are reacted at 98° C. in 62 g water-free acetone with 79 g hexamethylene diisocyanate for 1 hour 30 min. Then 130 g of water-free acetone is added over 4 h 30 min and the temperature reduced to 67° C. The reaction is continued to a NCO-content of 0.2%. The mixture is then diluted with 646 g of acetone and cooled to 57° C. Then 3.4 g of isophoronediamine (IPDA) diluted in 13.6 g acetone are added dropwise in 5 min and the mixture is stirred for 30 min. The mixture is neutralized with 23.8 g of a 5% strength of aqueous ammonia solution and the mixture is dispersed using 825 g of deionized water. The acetone is removed by distillation in vacuo, and solids content is adjusted to 45%.

Analysis values: LD: 84; pH: 7.6

### Example 6

453 g of a polyesterdiol made of adipic acid, 1,6-hexanediol and neopentyl glycol (OH number=56 mg KOH/g), 145 g of a polyesterdiol based on dimer fatty acid (Priplast® 3228, from Croda; OH number=56 mg KOH/g), 2.68 g trimethylolpropane and 13.4 g dimethylolpropionic acid (DMPA) are reacted at 96° C. in 62 g water-free acetone with 75.6 g hexamethylene diisocyanate for 1 hour. Then 130 g of water-free acetone is added over 5 hours and the temperature reduced to 65° C. The reaction is continued to a NCO-content of 0.19%. The mixture is then diluted with 646 g of acetone and cooled to 57° C. Then 3.4 g of isophoronediamine (IPDA) diluted in 13.6 g acetone are added dropwise in 5 min and the mixture is stirred for 30 min. The mixture is neutralized with 23.8 g of a 5% strength of aqueous ammonia solution and the mixture is dispersed using 900 g of deionized water. The acetone is removed by distillation in vacuo, and solids content is adjusted to 52%.

Analysis values: LD: 35; pH: 7.5

### Example 7

604 g of a polyesterdiol made of adipic acid, 1,6-hexanediol and neopentyl glycol (OH number=56 mg KOH/g), 0.94 g trimethylolpropane and 9.39 g dimethylolpropionic acid (DMPA) are reacted at 90° C. in 70 g water-free acetone with 70.9 g hexamethylene diisocyanate for 3 hours 30 min. Then 180 g of water-free acetone is added over 7 hours and the temperature reduced to 65° C. The reaction is continued to a NCO-content of 0.4%. The mixture is then diluted with 450 g of acetone and cooled to 57° C. The mixture is neutralized with 26.3 g of a 10% strength of aqueous sodium hydroxide solution and the mixture is dispersed using 664 g of deionized water. The acetone is removed by distillation in vacuo, and solids content is adjusted to 50%.

Analysis values: LD: 74; pH: 8.0
amorphous, no melting point; Tg: −52 ° C.

### Example 8

649.8 g of a polyesterdiol made of adipic acid, 1,4-butanediol and 2-methyl-1,3 propanediol (OH number=52mg KOH/g), and 13.4 g dimethylolpropionic acid (DMPA) are reacted at 94° C. in 62 g water-free acetone with 70.6 g hexamethylene diisocyanate for 2 h 30 min. Then 130 g of water-free acetone is added over 7 h and the temperature stepwise reduced to 67° C. The reaction is continued to a NCO-content of 0.2%. The mixture is then diluted with 646 g of acetone and cooled to 57° C. Then 3.4 g of isophoronediamine (IPDA) diluted in 13.6 g acetone are added dropwise in 5 min and the mixture is stirred for 30 min. The mixture is neutralized with 23.8 g of a 5% strength of aqueous ammonia solution and the mixture is dispersed using 795 g of deionized water. The acetone is removed by distillation in vacuo, and solids content is adjusted to 49%.

Analysis values: LD: 52; pH: 8.0

### Example 9

556 g of a polyesterdiol made of adipic acid, 1,6 hexanediol and neopentyl glycol (OH number=56 mg KOH/g), 150.9 g of a polyesterdiol made of adipic acid, 1,4 butanediol, ethylene-glycol and diethylene-glycol and glycerol (OH number=55mg KOH/g), and 15.4 g dimethylolpropionic acid (DMPA) are reacted at 94° C. in 71.3 g water-free acetone with 81.2 g hexamethylene diisocyanate for 2 hours 30 min. Then 150 g of water-free acetone is added stepwise over 4 h and the temperature stepwise reduced to 67° C. The reaction is continued to a NCO-content of 0.25%. The mixture is then diluted with 743 g of acetone and cooled to 57° C. Then 3.92 g of isophoronediamine (IPDA) diluted in 15.7 g acetone are added dropwise in 5 min and the mixture is stirred for 30 min. The mixture is neutralized with 28.4 g of a 5% strength of aqueous ammonia solution and the mixture is dispersed using 972 g of deionized water. The acetone is removed by distillation in vacuo, and solids content is adjusted to 45%.

Analysis values: LD: 84.5; pH: 7.6

To this dispersion a crosslinker was added as follows: 70 parts by weight of Basonat® LR 9056 (BASF; polyisocyanate based on isocyanurated hexamethylene diisocyanate) were mixed with 30 parts by weight of triacetin (a biodegradable plasticizer) in order to reduce the viscosity. Then 0.64 g of this mixture were added to 98.58 g of the polyurethane dispersion to obtain a ratio of 1 part Basonat® LR 9056 per 100 parts solid polyurethane.

### Example 10

551 g of a polyesterdiol made of adipic acid, 1,6-hexanediol and neopentyl glycol (molar ratio of 1,6-hexanediol : neopentyl glycol=1.8:1; OH number=56 mg KOH/g) and 20.1 g dimethylolpropionic acid (DMPA) are reacted at 70-75 ° C. in 169 g water-free acetone with 96.19 g hexamethylene diisocyanate to a NCO-content of 1.4%. The mixture is then diluted with 735 g of acetone and cooled to 35-38° C. The mixture is neutralized with 125.4 g of a 5% strength of aqueous sodium hydroxide solution and the mixture is dispersed using 1201 g of deionized water. A solution of 9.08 g diethylenetriamine (DETA) in 110 g deionized water is added dropwise in 10 min. The mixture is diluted with 127 g water and the acetone is removed by distillation in vacuo, and solids content is adjusted to 30%.

Analysis values: LD: 97; pH: 8.9; Tg: −42 ° C.
amorphous, no melting point detectable

### Example 11 (Comparative)

Polyurethane dispersion adhesive made according to example 1 of WO 2012/013506 A1; melting point: 52° C.; enthalpy of fusion: 60 J/g Tg: −51° C.

### Example 12 (Comparative)

Polyetherol based polyurethane dispersion adhesive made according to example 1 of WO 2006/087348 A1 (EP 1853640).

### Example 13

725 g of a polyesterdiol made of adipic acid, 1,6-hexanediol and neopentyl glycol (OH number=56 mg KOH/g), 10.6 g dimethylolpropionic acid (DMPA) are reacted at 75-78° C. in 120 g water-free acetone with 81.2 g hexamethylene diisocyanate until a NCO-value of 0.43%. The mixture is then diluted with 600 g of acetone and cooled to 57° C. The mixture is neutralized with 31.6 g of a 7.6% strength of aqueous sodium hydroxide solution and 8.2 g of a water-dispersible polyisocyanate based on hexamethylene diisocyanate (Basonat® LR 9056, BASF) diluted in 16.4 g of acetone is mixed in and the mixture is dispersed using 791 g of deionized water. The acetone is removed by distillation in vacuo, the solids content reached 53.6%).

Analysis values: LD: 40.8; pH: 7.6
Tg −53° C.; no melting point detected

### Example 14

485 g of a polyesterdiol made of adipic acid, 1,6-hexanediol and neopentyl glycol (OH number=56 mg KOH/g), 248.4 g of a polyesterdiol made of adipic acid, ethylene-glycol and diethylene-glycol (OH number=46 mg KOH/g), 0.9 g glycerol and 11.27 g dimethylolpropionic acid (DMPA) are reacted at 75-78° C. in 60 g water-free acetone with 82.5 g hexamethylene diisocyanate for 5 hours. Then two times 30 g water-free acetone is added slowly and the temperature decreased to 70° C. The reaction is continued to a NCO-content of 0.43%. The mixture is then diluted with 600 g of acetone and cooled to 57° C. The mixture is neutralized with 31.6 g of a 10% strength of aqueous sodium hydroxide solution and the mixture is dispersed using 802 g of deionized water. The acetone is removed by distillation in vacuo, and solids content is adjusted to 49%.

Analysis values: LD: 82; pH: 8
Tg −49° C.; no melting point detected

### Example 15

The above experiment (example 13) is repeated with the difference, that the polyesterol-mixture is reacted with 29 g of hexamethylene diisocyanate in the melt at 85° C. until the NCO-groups are fully consumed. The melt is cooled to 60° C., all other components of the precharge are added and carefully mixed in and the reaction is continued with the remaining hexamethylene diisocyanate as described above. After NCO-value reached 0.43%, the mixture is then diluted with 600 g of acetone and cooled to 57° C. The mixture is neutralized with 31.6 g of a 10% strength of aqueous sodium hydroxide solution and the mixture is dispersed using 802 g of deionized water. The acetone is removed by distillation in vacuo, and solids content is adjusted to 47%.

Analysis values: LD: 82.4; pH: 7.7
Tg −49.4° C.; no melting point detected

### Example 16

601 g of a polyesterdiol made of adipic acid, 1,6-hexanediol and neopentyl glycol (OH number=56 mg KOH/g), 27 g of a polyethylene glycol of molecular weight 600 (Pluriol® E 600, BASF), 0.9 g glycerol and 11.27 g dimethylolpropionic acid (DMPA) are reacted at 75-78° C. in 60 g water-free acetone with 82.5 g hexamethylene diisocyanate for 5 hours. Then 60 g water-free acetone is added slowly and the temperature decreased to 70° C. The reaction is continued to a NCO-content of 0.48%. The mixture is then diluted with 600 g of acetone and cooled to 57° C. The mixture is neutralized with 31.6 g of a 10% strength of aqueous sodium hydroxide solution and the mixture is dispersed using 697 g of deionized water. The acetone is removed by distillation in vacuo, additional 613 g deionized water are added during distillation and solids content reaches 35%.

Analysis values: LD: 86.2; pH: 7.5
Tg −52° C.; no melting point detected

Composting Test

Home compostability is tested according to Australian Standard AS 5810-2010 and ISO 14855-1 (2012) “Determination of the ultimate aerobic biodegradability of plastic materials under controlled composting conditions—Method by analysis of evolved carbon dioxide” at ambient temperature (28±2° C.) to simulate home composting conditions instead of the described temperature of 58° C.

The results are summarized in table 1.

TABLE 1
Results of home compostability tests

| | | Days after which |
|---|---|---|
| | Days for 90% biological | no residues are |
| | degradation at 28° C. | visibly detectable |
| Example 10 | 90 | 110 |
| Example 11 (comparative) | >360 | >360 |
| Example 4 | 37 | |
| Example 7 | 57 | |
| Celullose (reference) | 21 | |

Based on these results, similar home compostability as for example 10 is expected for examples that are of similar composition and/or that show the same degradability in a prescreening enzyme-based quick test as described herein.

### Enzyme-Based Quick-Test for Biodegradability

For evaluating potential biodegradability, an enzyme-based quick-test was applied according to Tokiwa's method (Nature 270, 76, 1977) to simulate home-compostability. Enzymes are able to hydrolyze ester-bonds in polymers, the resulting carboxylic acids cause a drop in pH, visible with the help of a pH-indicator and a photometer.

If a comparison is made of the test results of degradation caused by enzymes of polyurethane dispersion adhesives with the home compost test results under home compost conditions of these polyurethane dispersion adhesives (see example 10), a good correlation is found between the ability to degrade with enzymes and the ability to degrade under home compost conditions. Comparative control probes, such as polyurethane dispersion adhesives which will not degrade at all (example 12; polyetherol based polyurethane), do not show any sign of enzyme degradation, while polyurethane dispersion adhesives that only are compostable under industrial conditions (example 11), will show only slow degradation with enzymes in this test.

Reagents and Substances used:

Buffer:

20 mM phosphate-buffer, pH 7.0

Stock solution: 13.6 g potassium dihydrogenphosphate KH₂PO4 (Sigma; P9791) is dissolved in 800 ml deionized water. The pH is adjusted by adding NaOH to pH 7. The solution is completed by filling to 1000 ml with deionized water

Enzymes:

Rhizopus oryzae Lipase (Sigma; 62305)

Pseudomonas fluorescens Esterase (Sigma; 75742)

Pseudomonas cepacia Lipase (Sigma; 62309)

Pseudomonas sp. Cholesterol Esterase (Creative Enzymes; DIA-134)

Pseudomonas sp. Lipoprotein Lipase (Creative Enzymes; DIA-210)

All Enzymes are dissolved in 20 mM phosphate-buffer (pH 7.0) and stabilized with 50% (v/v) glycerol for storage at −20° C. A stock-solution with 100 U/m1 of each enzyme is prepared.

pH-indicator:

pH-indicator is bromothymol blue (Sigma; B8630). A stock solution is prepared by dissolving 200 mg bromothymol blue in 100 ml potassium phosphate-buffer (5 mM, pH 7.0).

Control:

Polycaprolactone powder (PCL; Sigma; 440744) is used as a control substrate.

Test Vessels:

A 96-Microwell plate (Sigma; TMO267556) is used as test vessels.

Photometer:

The test assays are analyzed by a photometer (Microwell-Reader; Tecan Infinite M1000 Pro).

Test Procedure:

For one substrate, the following substances are prepared:

3× test substance à 200 μl:
0.5% (w/v) test substance
20 mM phosphate-buffer (pH 7.0)
0.2 mg/ml bromothymol blue
5 U/ml for each enzyme

1× test blind à 200 μl:
0.5% (w/v) test substance
20 mM phosphate-buffer (pH 7.0)
0.2 mg/ml bromothymol blue

3× control à 200 μl:
0.5% (w/v) polycaprolactone
20 mM phosphate-buffer (pH 7.0)
0.2 mg/ml bromothymol blue
5 U/ml for each enzyme

1× control blind à 200 μl:
0.5% (w/v) polycaprolactone
20 mM phosphate-buffer (pH 7.0)
0.2 mg/ml bromothymol blue

1× enzyme blind à 200 μl:
20 mM phosphate-buffer (pH 7.0)
0.2 mg/ml bromothymol blue
5 U/m1 for each enzyme

1× buffer blind à 200 μl:
20 mM phosphate-buffer (pH 7.0)
0.2 mg/ml bromothymol blue

The substrates to be tested are prepared as 5% (w/v) solutions in DMSO. Buffer, pH-indicator and enzymes are mixed in their final concentrations and preheated to 37° C. Amounts of 20 μl stock-solution of test substance (or control substance) are precharged per well and 180 μl of reaction mixture are added to start the reaction and placed into the reader. The microwell plate is heated to 37° C. while shaking. The measurement is continued over several hours. The absorptions at 433 nm and at 615 nm are recorded every 5 min. Both wavelengths are the maxima of absorption of bromothymol blue at different states of protonation, depending on pH.

Test results can be documented by photographs or in a chart depending on time. The absorption quotient of the absorptions at 433 nm and at 615 nm is used as signal readout. In a mixture of 20 mM phosphate buffer (pH 7.0) and 0.2 mg/ml bromothymol blue the absorption quotient 433 nm/615 nm has the value 0.5. The higher the quotient, the lower the pH. The higher the pH change compared to the control-substance, the higher the enzymatic degradation of the test substance.

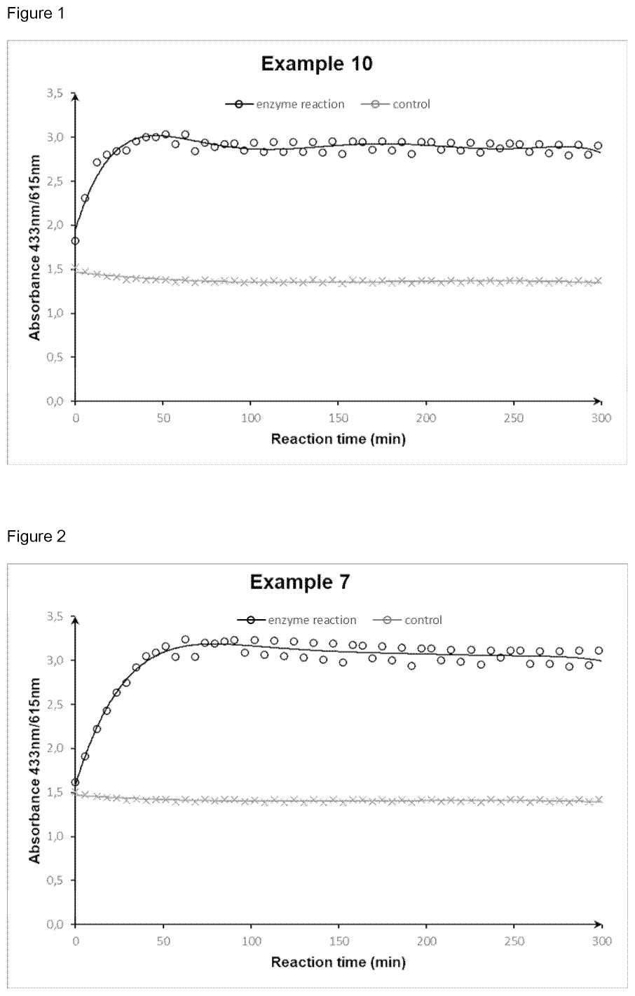

Inventive examples 4 to 8 and 10 are tested in the enzyme degradation test and compared to example 11 (example 1 of WO2012/013506) and example 12 (example 1 of WO 2006/087348 A1). The results of the enzyme degradation tests are demonstrated in FIGS. 1 to 8.

FIG. 1:

FIG. 1 shows the development of the 433 nm/615 nm absorbance ratio over time for polyurethane of example 10. The 433 nm/615 nm absorbance ratio shows a steep increase, reaching a plateau within 50 minutes. This is a good correlation with the composting test results of example 10 described above.

FIG. 2:

FIG. 2 shows the development of the 433 nm/615 nm absorbance ratio over time for polyurethane of example 7. The 433 nm/615 nm absorbance ratio shows a steep increase, reaching a plateau in less than 100 minutes.

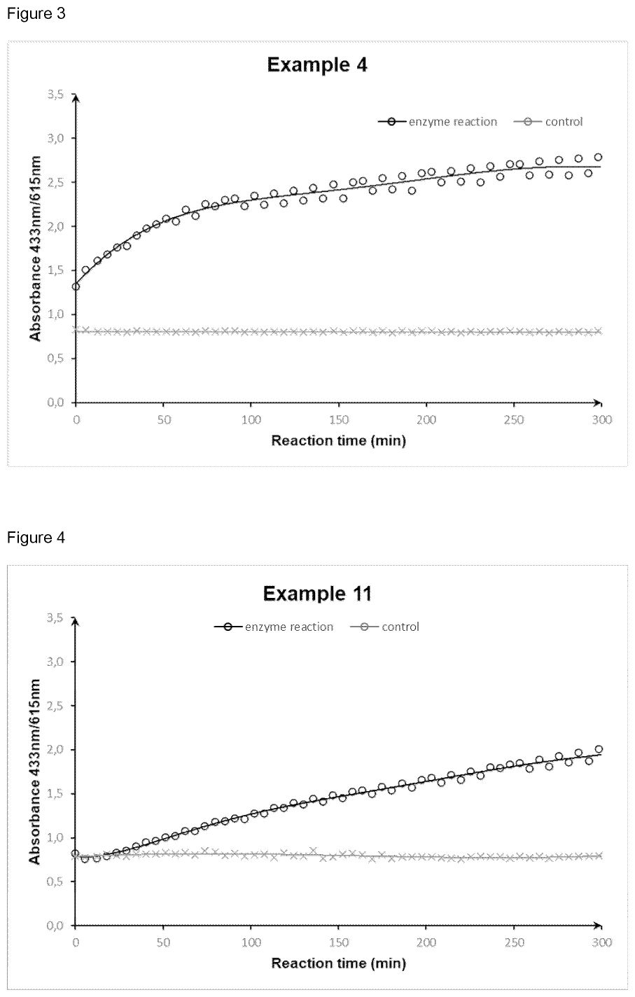

FIG. 3:

FIG. 3 shows the development of the 433 nm/615 nm absorbance ratio over time for polyurethane of example 4. The 433 nm/615 nm absorbance ratio shows a steep increase at the beginning, reaching a plateau in less than 300 minutes.

FIG. 4:

FIG. 4 shows the development of the 433 nm/615 nm absorbance ratio over time for polyurethane of example 11 (comparative example; example 1 of WO 2012/013506 A1). The 433 nm/615 nm absorbance ratio shows a shallow increase, not reaching a plateau within 300 minutes. This is a good correlation with the composting test results described above. This example is industrial compostable (compostable at the elevated temperatures of industrial compost facilities) but significantly less compostable at the lower temperatures of home-compost conditions.

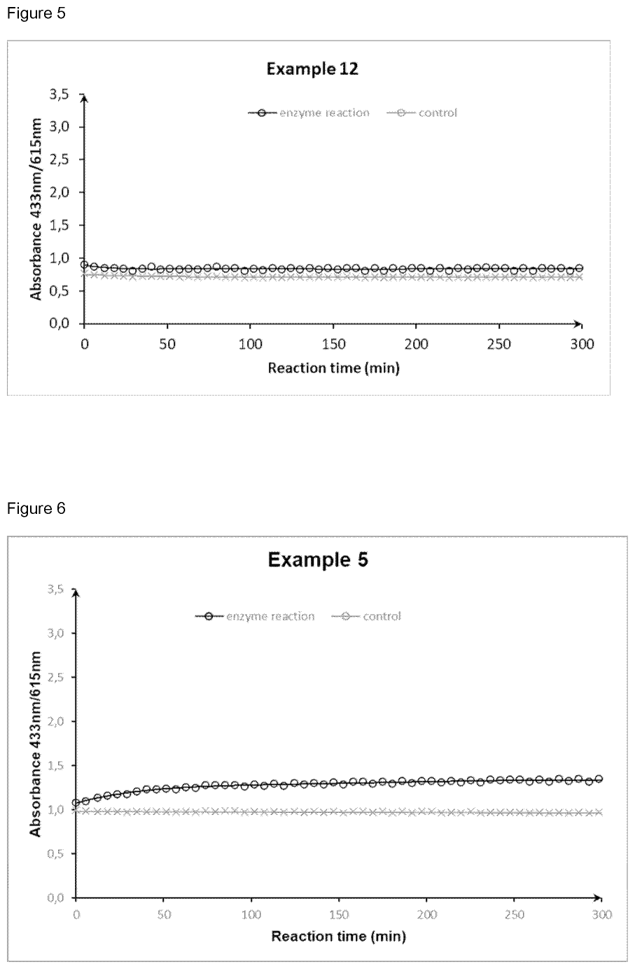

FIG. 5:

FIG. 5 shows the development of the 433 nm/615 nm absorbance ratio over time for polyurethane of example 12 (comparative example; example 1 of WO 2006/087348 A1). There is no increase of the 433 nm/615 nm absorbance ratio and therefore no enzymatic degradation under the test conditions.

FIG. 6:

FIG. 6 shows the development of the 433 nm/615 nm absorbance ratio over time for polyurethane of example 5. The 433 nm/615 nm absorbance ratio shows a steep increase at the beginning, reaching a plateau in less than 100 minutes.

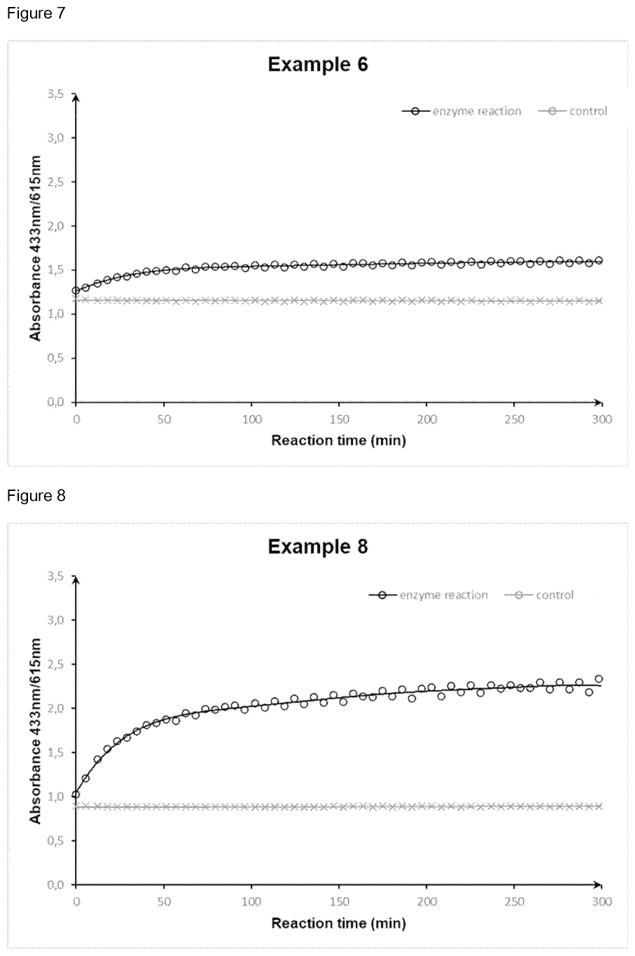

FIG. 7:

FIG. 7 shows the development of the 433 nm/615 nm absorbance ratio over time for polyurethane of example 6. The 433 nm/615 nm absorbance ratio shows a steep increase at the beginning, reaching a plateau in less than 100 minutes.

FIG. 8:

FIG. 8 shows the development of the 433 nm/615 nm absorbance ratio over time for polyurethane of example 8. The 433 nm/615 nm absorbance ratio shows a steep increase at the beginning, reaching a plateau in less than 300 minutes.

The results of the enzyme degradation tests are shown in FIGS. 1 to 8. Home-compostable materials (examples 4, 5, 6, 7, 8 and 10; FIGS. 1, 2, 3, 6, 7 and 8) show a steep increase in the 433 nm/615 nm absorbance ratio (quick enzymatic degradation) within the first 50 minutes and reach a plateau (full enzymatic degradation, based on the enzymes used) within 300 minutes. Non-home compostable materials (examples 11 and 12; FIGS. 4 and 5, respectively) either show no or only a low increase in the 433 nm/615 nm absorbance ratio (no or slow enzymatic degradation) within the first 50 minutes and do not reach a plateau (no full enzymatic degradation with the enzymes used) within 300 minutes.

Preparation of Adhesive Sheets (Paper Labels with Siliconized Release Paper)

The aqueous polyurethane dispersions of selected examples were mixed with a wetting agent (Lumiten® I-SC, BASF) to obtain a mixture containing 1 g (solid) of wetting agent per 100 g (solid) of polyurethane. The mixture was then applied to a siliconized release paper using a bar coater and dried in an oven at 90° C. for 3 minutes. The dry application weight was 17 g/m 2 . The adhesive layer was covered with a 70 g/m² label face paper to obtain an adhesive laminate sheet. The sheets were conditioned at 23° C. and 50% relative humidity (rH) for at least 16 hours before testing.

Adhesive Testing

Loop tack measurement and 90° peel adhesion tests were carried out as described in FINAT test method no. 9 and FINAT test method no. 2 respectively. However, instead of using float glass, test substrates were prepared by attaching paper strips to a rigid substrate using a double-sided adhesive tape. The same label face paper was used as for the preparation of the adhesive sheets. If not stated otherwise, samples are rolled on to the substrate with a standard FINAT test roller at 10 mm/s. The peel tests were carried out after a contact time of 20 min (or 1 min as indicated) and 24 h. If not stated otherwise, conditioning, contact and testing is carried out at 23° C. and 50% relative humidity.

A value of more than 3 N/25 mm in loop tack and peel tests indicates a polymer suitable for pressure-sensitive adhesive applications.

The test results are shown in table 2. The values are averages of three replicates.

TABLE 2
Loop tack measurement and 90° peel adhesion test results

| | | Test | | | | | |
|---|---|---|---|---|---|---|---|
| | | Loop Tack | | 90° Peel Adhesion | | 90° Peel Adhesion | |
| | | Substrate | | | | | |
| | | Paper | | Paper | | Paper | |
| | | Conditioning | | | | | |
| | | >16 h | | >16 h | | >16 h | |
| | | Contact | | | | | |
| | | instantly | | 20 min | | 24 h | |
| | | Test | | | | | |
| | | 300 mm/min | | 300 mm/min | | 300 mm/min | |
| | | Measure | | | | | |
| | | F max | | F avg | | F avg | |
| Example | Unit | [N/25 mm] | failure | [N/25 mm] | failure | [N/25 mm] | failure |
| 1+ | Avg | 7.1 | CP | 10.1 | CP | 10.9 | CP/CF/PT |
| 2 | Avg | 6.1 | CP | 10.3 | CP/PT | 11.7 | CP/PT |
| 4 | Avg | 4.4 | CF/CP | 4.1 | CF | 4.8 | AT/CF |
| 5 | Avg | 7.3 | CP | 15.8 | CF | 12.5 | CF |
| 6 | Avg | 7.3 | CF | 10.1 | CP | 13.0 | CF |
| 7 | Avg | 3.5 | CP | 17.1 | | 21.2 | PT |
| 8 | Avg | 4.8 | CF | 11.5 | CP/CF | 12.5 | CF |
| 9 | Avg | 5.6 | CF | 5.1 | CF | 6.9 | CF |
| 13 | Avg | 4.2 | CP | 7.2 | CP | 16.0 | PT |
| 14 | Avg | 6.9 | CP | 14.6 ¹⁾ | PT/CP | 26.9 | PT/CP |
| 15 | Avg | 7.6 | CP | 14.4 ¹⁾ | CP/PT | 27.3 | PT |
| 16 | Avg | 3.0 | CP | 10.6 ¹⁾ | CP/PT | 17.3 | PT |

¹⁾ contact time1 min
CP = Clear panel - no visible stain on panel
PS = Panel Stain - discoloration of test area, but no tacky residue.
CF = Cohesive Failure - the adhesive film is split during the test, leaving residue of adhesive on both the panel and the front material.
AT = Adhesive Transfer - the adhesive separates cleanly from the front material, leaving adhesive film on the test panel.
PT = Paper Tear - the adhesive force exceeds the strength of a paper facing material. The results quoted should be the maximum reached before the paper tears

The decomposition tests and the adhesive tests show that the tested examples can be used for pressure sensitive adhesive label applications to gain e.g. home compostable labels for flexible packaging .

1.-17. (canceled)

18. An adhesive label comprising a backing material having a first side and a second side, a pressure-sensitive adhesive layer attached to the first side of the backing material and either a release liner attached to the adhesive layer, or a release coating on the second side of the backing material,
wherein the backing material is made of paper or home compostable polymer film, and the pressure-sensitive adhesive layer is made from an aqueous polyurethane dispersion pressure-sensitive adhesive,
where at least 60% by weight of the polyurethane is composed of
(a) at least one diisocyanate,
(b) at least one polyesterdiol, and
(c) at least one bifunctional carboxylic acid selected from dihydroxy carboxylic acids and diamino carboxylic acids;
wherein the polyurethane has a glass transition temperature below 20° C.,
wherein the polyurethane either has no melting point above 20° C. or wherein the polyurethane has a melting point above 20° C. with an enthalpy of fusion lower than 10 J/g.

19. The adhesive label according to claim 18, wherein a film of the polyurethane adhesive decomposes at home compost conditions to more than 90% by weight into CO₂ and water within 360 days.

20. The adhesive label according to claim 18, wherein the surface energy of the release liner or the surface energy of the release coating is less than 30 mN/m; and the release liner is siliconized paper.

21. The adhesive label according to claim 18, wherein the loop tack measured as described in the examples is at least 3 N/25 mm.

22. The adhesive label according to claim 18, wherein the 90° peel adhesion measured after 24 hours contact time as described in the examples is at least 3 N/25 mm.

23. The adhesive label according to claim 18, wherein the polyesterdiol is either made of at least one diacid and at least one branched diol or wherein the polyesterdiol is liquid at 20° C.

24. The adhesive label according to claim 18, wherein the ratio of isocyanate groups to groups reactive with isocyanates is at least 1 when making the polyurethane.

25. The adhesive label according to claim 18, wherein at least 60% by weight of the polyurethane is composed of
(a) at least one aliphatic diisocyanate,
(b) at least one aliphatic polyesterdiol,
(c) at least one bifunctional carboxylic acid selected from dihydroxycarboxylic acids and diaminocarboxylic acids, and
(d) at least one polyfunctional compound which differs from the monomers (a) to (c) and which has at least two reactive groups selected from primary and secondary amino groups.

26. The adhesive label according to claim 18, wherein at least 80% by weight of the polyurethane is composed of at least one aliphatic polyesterdiol (b).

27. The adhesive label according to claim 18, wherein at least 80% by weight of the at least one polyesterdiol (b) is composed of at least one aliphatic dicarboxylic acid and of at least one aliphatic diol.

28. The adhesive label according to claim 18, wherein the polyesterdiol is made of at least 10 mol % based on the sum of diols used for making the polyesterdiol of branched aliphatic diols.

29. The adhesive label according to claim 18, wherein the polyurethane is composed of
(a) at least one diisocyanate,
(b) at least one diol, where, of these,
b1) from 10 to 100 mol %, based on the total amount of the diols (b), are polyesterdiols with a molar mass of from 500 to 5000 g/mol,
b2) from 0 to 90 mol %, based on the total amount of the diols (b), have a molar mass of from 60 to 500 g/mol,
(c) at least one bifunctional carboxylic acid selected from dihydroxycarboxylic acids and diaminocarboxylic acids,
(d) optionally other polyfunctional compounds which differ from the monomers (a) to (c) and which have reactive groups, where these are alcoholic hydroxy groups, primary or secondary amino groups, or isocyanate groups, and
(e) optionally monofunctional compounds which differ from the monomers (a) to (d) and which have a reactive group which is an alcoholic hydroxy group, a primary or secondary amino group, or an isocyanate group,
wherein the polyurethane comprises bio-based materials.

30. The adhesive label according to claim 18, wherein the polyurethane is made of at least 80 wt. % of polyesterols, based on the total weight of the polyurethane, less than 20 wt. % isocyanate compounds, based on the total weight of the polyurethane and comprises less than 100 mmol/kg of urea groups.

31. The adhesive label according to claim 18, wherein the polyurethane dispersion adhesive comprises at least one external crosslinking agent selected from the group consisting of isocyanurates formed from diisocyanates and having at least two isocyanate groups, compounds having at least one carbodiimide group, chemically capped isocyanates, encapsulated isocyanates, encapsulated uretdiones, biurets, allophanates, aziridines, oxazolines, epoxides, and mixtures thereof.

32. The adhesive label according to claim 18, wherein the backing material is home compostable and selected from paper, polylactic acid, lignin, starch, cellulose materials, polyglycolic acid, polyhydroxyalkanoates, polypropylene carbonate, aliphatic polyesters, aliphatic-aromatic copolyesters and mixtures thereof.

33. A method comprising utilizing an aqueous polyurethane dispersion pressure-sensitive adhesive for making an adhesive label, comprising a backing material having a first side and a second side, a pressure-sensitive adhesive layer attached to the first side of the backing material and either a release liner attached to the adhesive layer, or a release coating on the second side of the backing material, wherein the backing material is made of paper or home compostable polymer film, and the pressure-sensitive adhesive layer is made from an aqueous polyurethane dispersion pressure-sensitive adhesive,
where at least 60% by weight of the polyurethane is composed of
(a) at least one diisocyanate,
(b) at least one polyesterdiol, and
(c) at least one bifunctional carboxylic acid selected from dihydroxy carboxylic acids and diamino carboxylic acids;
wherein the polyurethane has a glass transition temperature below 20° C.,
wherein the polyurethane either has no melting point above 20° C. or wherein the polyurethane has a melting point above 20° C. with an enthalpy of fusion lower than 10 J/g.

34. The method according to claim 33, wherein a film of the polyurethane adhesive decomposes at home compost conditions to more than 90% by weight into CO₂ and water within 360 days.
